(19) United States
(12) Patent Application Publication
(10) Pub. No.: US 2006/0103049 A1
(43) Pub. Date: May 18, 2006

(54) Magnetized Core with Pneumatic Release System for Creating a Wax Mold for a Golf Club Head

(76) Inventors: Maurice Duquette, Escondido, CA (US); Broadus Perry Wall JR., Carlsbad, CA (US); Brent Anderson, Carlsbad, CA (US)

Correspondence Address: CALLAWAY GOLF C0MPANY, 2180 RUTHERFORD ROAD, CARLSBAD, CA, 92008-7328, US

(21) Appl. No.: 11/275,338

(22) Filed: Dec. 27, 2005

Related U.S. Application Data
(62) Division of application No. 10/248,072, filed on Dec. 16, 2002, now Pat. No. 6,978,976.
Application No. 10/248,072 is a continuation-in-part of application No. 60/343,982, filed on Dec. 26, 2001.

(51) Int. Cl. B29C 33/40

(52) U.S. Cl. 264/219; 264/335

(57) ABSTRACT

An improved core for creating wax patterns of golf club heads is disclosed herein. The core includes a center core piece and several outer core pieces removably coupled to the center core piece by magnets embedded in each of the core pieces. The core further includes a pneumatic release system, including a manifold, to easily separate the center core piece from the outer core pieces and expel the center core piece from a wax pattern, thereby eliminating the need to pry and pull pieces out with a tool, which could damage the wax pattern of the golf club head.

### CROSS REFERENCES TO RELATED APPLICATIONS

The Present Application is a divisional Application of U.S. patent application Ser. No. 10/248,072, filed Dec. 16, 2002, which claims priority to U.S. Provisional Patent Application NO. 60/343,982 filed on Dec. 26, 2001

### STATEMENT REGARDING FEDERALLY SPONSORED RESEARCH OR DEVELOPMENT

Not Applicable

### BACKGROUND OF THE INVENTION

1. Field of the Invention

The present invention relates to investment cast molding tools for the manufacture of golf club heads. More specifically, the present invention relates to an investment cast molding apparatus for the construction of metal wood-type golf club heads.

2. Description of the Related Art

One of the oldest methods of forming golf club heads is through investment casting. This process is currently used to produce the majority of wood-type golf club heads. In this process, a resin mold, which includes two plates composed of aluminum hinged at one end and having a hollow center, is used. A master copy of the golf club head to be produced is suspended in the hollow center and a liquid resin is poured around the master copy to create the outer shape of the golf club head upon solidification of the resin.

In hollow metal wood-type golf club heads, the interior shape of the golf club head is produced by an aluminum core, which typically consists of five pieces. Wax is injected into the mold to fill the space between the inner and outer shapes of the golf club head. The mold is opened and the aluminum core with the wax pattern around it is removed. The aluminum core is separated from the wax pattern by first removing a center piece of the core. The remaining pieces of the core may then be shifted around and removed through the opening that was created by removal of the center core piece. When all of the pieces of the core have been removed, the wax pattern of the golf club head will have a large hole in the either crown or sole, through which the aluminum core was removed. This hole will be covered by a plate, which is typically welded about its perimeter to the golf club head. The weld is then sanded smooth to blend with the rest of the golf club head.

There are several areas with this apparatus and manufacturing process that could be improved. First, the removal of the core from the wax pattern and mold can be time-consuming and laborious. Typically, a tool is inserted into openings formed in the base of the core and used to pry the individual core pieces from the wax pattern and mold. The tool may slip and can damage the core, wax pattern and/or the mold. Second, extraction of the first core piece from the mold can create a suction force on the wax pattern, drawing the wax pattern away from the mold and damaging it. Third, the individual core pieces, which are designed to slide in a longitudinal direction with respect to each other so as to enable their removal from the wax pattern, lack a means for restricting movement in the longitudinal direction during insertion of the core into the cavity of the mold. Thus, as the core is being placed in the mold cavity, individual core pieces can slide relative to the others and damage either themselves or the mold.

Thus, there is a need for an improved aluminum core that stays together during insertion of the core in a mold and is easy to remove from a wax mold.

### BRIEF SUMMARY OF THE INVENTION

The present invention is an improved core for producing hollow wax patterns of golf club heads. The improved core includes a center core piece and a plurality of outer core pieces. Each of the outer core pieces is removably coupled to a respective side wall of the center core piece. Magnets embedded in each of the core pieces secure the various core pieces together. The improved core further includes a pneumatic release system to easily separate the center core piece from the outer core pieces and expel the center core piece from the wax mold. The pneumatic release system eliminates the need to pry and pull pieces out with a tool, which could damage the wax pattern of the golf club head.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a top plan view of an apparatus and a core for forming a golf club head in accordance with the present invention.

FIG. 2 is a front plan view of the core shown in FIG. 1.

FIG. 3 is a top plan view of the core of FIG. 2.

FIG. 4 is a partial exploded perspective view of the core of FIG. 2.

FIG. 5 is a top plan view of the manifold of the core of FIG. 2.

FIG. 6 illustrates a center piece of the core of FIG. 2 being expelled from a wax pattern.

### DETAILED DESCRIPTION OF THE INVENTION

The present invention is directed to an apparatus and a method for producing hollow wax patterns of golf club heads, and more particularly a hollow metallic wood-type golf club head. The improved core of the present invention has magnets embedded in each of the core pieces to secure the individual core pieces together. The core further includes a pneumatic release system for separating the center core piece from the outer core pieces and expelling the center core piece from a wax mold, without the use of a prying tool and without damage to the wax pattern.

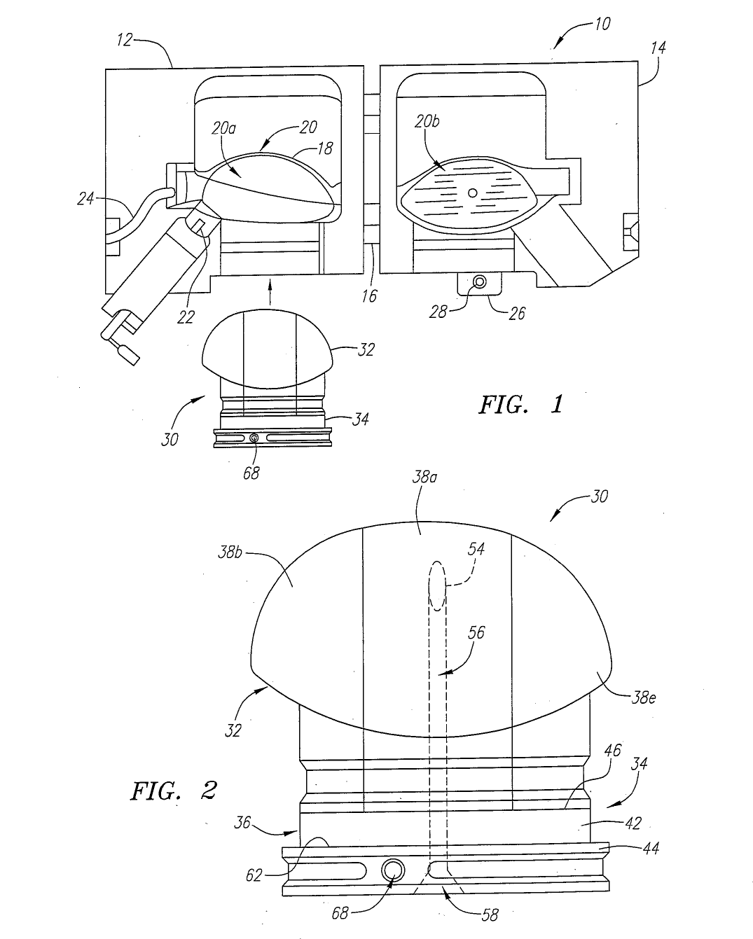

FIG. 1 illustrates an apparatus 10 for forming a golf club head in accordance with the present invention. Apparatus 10 includes a first half 12 and a second half 14, which are coupled together by a hinge 16. First and second halves 12 and 14 make up a mold 18 that has a mold cavity 20, one portion 20a of which is formed in first half 12, and another portion 22b of which is formed in second half 14. When the two halves 12 and 14 of apparatus 10 are brought together in a closed position, portions 20a and 20b register together to form a single, complete mold cavity 20.

Mold cavity 20 has a shape generally complementary to the exterior of the desired golf club head, with cavity portion 20a forming a majority of the club head exterior, and cavity portion 20b forming the a front portion of the club head. Apparatus 10 includes a telescoping insert pin 22 for forming the space in the golf club head that will later be occupied by a golf club shaft.

Mold cavity 20 is designed to receive a core 30. As will be described in greater detail below, core 30 is comprised of multiple of core pieces. Core 30 has an upper portion 32 that is generally identical in size and shape to an interior of the golf club head. Core 30 further includes a lower portion 34 that extends from mold cavity 20 of apparatus 10, when core 30 is placed in mold 18.

Apparatus 10 further includes a supply duct 24 for directing injected wax into mold cavity 20 and around core 30. In addition, apparatus 10 includes a spring lock 26 mounted on second half 14. Spring lock 26 includes a retractable locking pin 28 that engages an aperture in core 30 to firmly fix the core 30 in mold cavity 20. Additional information about wax molding methods and articles for manufacturing golf club heads is disclosed in U.S. Pat. Nos. 5,547,360, 5,577,550, 5,204,046, 5,669,828 and 5,417,559, all of which are hereby incorporated by reference in their entirety.

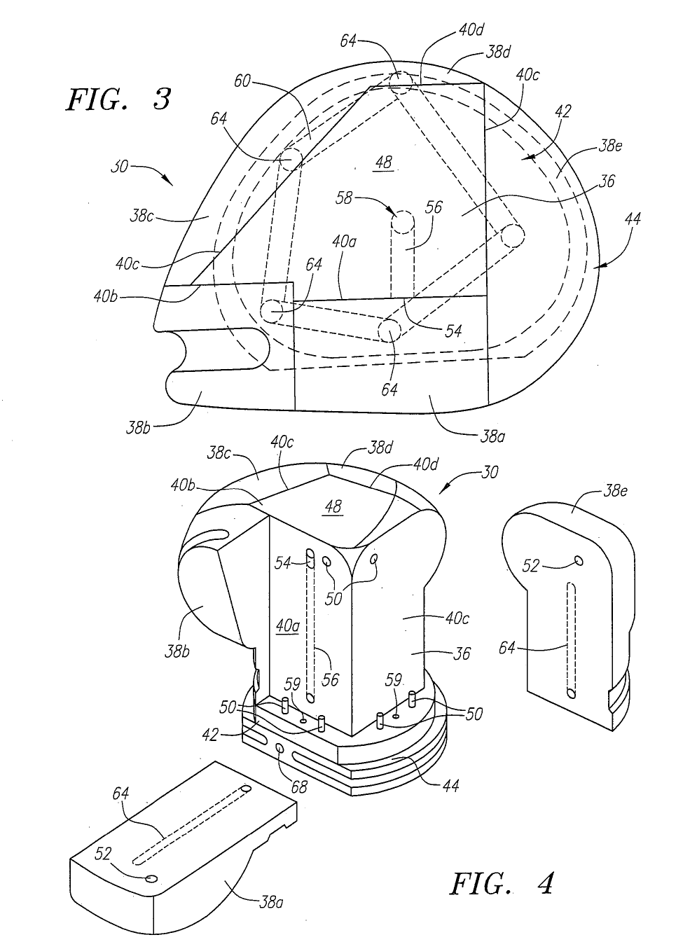

FIGS. 2-4 illustrate core 30 in greater detail. Core 30 is preferably made of a metal, such as aluminum. Core 30 includes a center core piece 36 and outer core pieces 38a-38e. Each outer core piece 38a-38e has a planar surface that is flush with a respective planar side wall 40a-40e of center core piece 36. Although five outer core pieces 38a-38e are depicted in the drawings, one of ordinary skill in the art will appreciate that core 30 may have fewer than or greater than five outer core pieces as well.

Center core piece 36 includes a base 42 and a manifold 44. Base 42 has a generally planar upper surface 46, from which side walls 40a-40e extend upward to a top surface 48 of center core piece 36. Top surface 48 of center core piece 36 forms a portion of an interior wall of the golf club head. Pins 50 project from upper surface 46 of base 42 and are received in respective openings (not shown) formed in outer core pieces 38a-38e. Pins 50 align outer core pieces 38a-38e with respect to center core piece 36 and restrict the movement of outer core pieces 38a-38e relative to center core piece 36 to a single direction.

Center core piece 36 further includes a magnet 50 embedded in each side wall 40a-40e thereof. Magnets 50 are preferably located proximate top surface 48 of center core piece 36, however, one of ordinary skill in the art will appreciate that magnets 50 may be located at other suitable locations along side walls 40a-40e. Each side wall 40a-40e may further include more than one magnet 50. A magnet 52 is embedded in the planar surface of each outer core piece 38a-38e at a corresponding location. Magnets 50 and 52 removably secure outer core pieces 38a-38e to center core piece 36. Each magnet 50 is flush with a respective side wall 40a-40e of center core piece 36. Similarly, each magnet 52 is flush with the planar surface of the outer core piece 38a-38e. Thus, outer core pieces 38a-38e may be slid along the respective side wall 40a-40e of center core piece 36 without any interference from magnets 50 and 52. Magnets 50 and 52 prevent unwanted movement of outer core pieces 38a-38e with respect to center core piece 36, such as during insertion of core 30 into cavity 20 of apparatus 10. Without magnets 50 and 52, outer core pieces 38a-38e may separate from center core piece 36 and damage either themselves or mold 18.

One side wall 40a of center core piece 36 has an opening 54 formed therein. Opening 54 is located near top surface 48 of center core piece 36. Opening 54 leads to a passage 56 that extends through base 42 and manifold 44 of center core piece 36. Passage 54 and opening 56 are part of the pneumatic release system for expelling center core piece 36 from a wax pattern.

Manifold 44, which is attached to base 42 of center core piece 36, completes the pneumatic release system. Manifold 44 has an opening 58 that is aligned with passage 54 in base 42. As illustrated in FIG. 5, manifold 44 further includes a groove 60 formed in an upper surface 62 of manifold 44. Groove 60 connects a chamber 64 formed in each of the outer core pieces 38a-38e, through additional openings 59 formed in base 42, to a vent hole 66.

Manifold 44 also helps to position and align core 30 in mold cavity 20. Manifold 44 includes an aperture 68 for receiving retractable locking pin 28 of spring lock 26 to secure core 30 in mold cavity 20. Thus, when core 30 is placed in mold cavity portion 20a and apparatus 10 is closed, the locking pin 28 of spring lock 26 engages aperture 68 in manifold 44 to positively lock core 30 in place (FIG. 5).

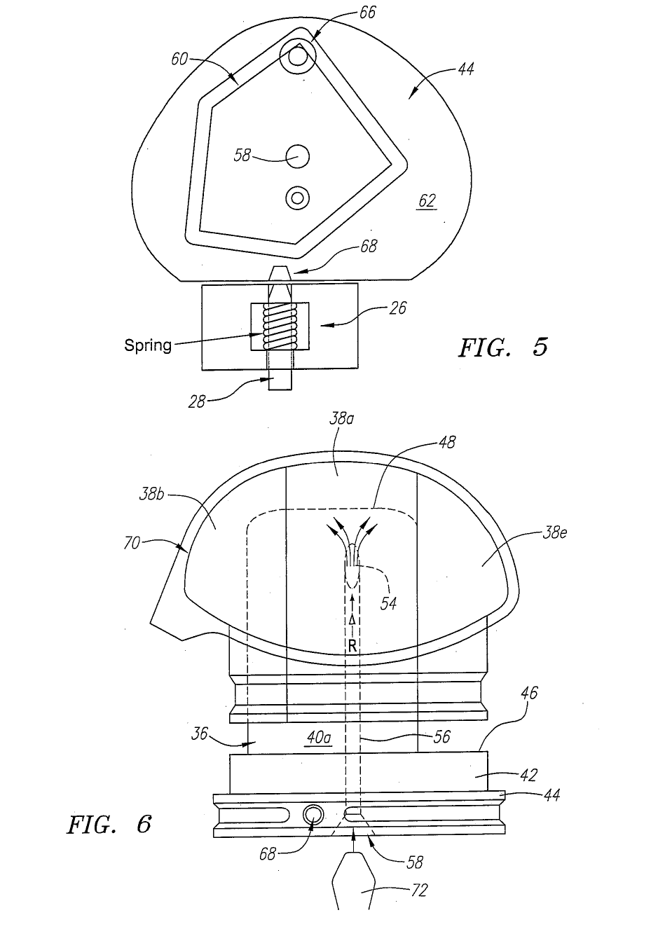

With core 30 secured in mold cavity 20 of apparatus 10, wax is introduced to supply duct 24 and injected into mold cavity 20. The wax encases top portion 32 of core 30 and forms a wax pattern 70 of a hollow golf club head. FIG. 6 illustrates wax pattern 70 formed about top portion 32 of core 30. When wax pattern 70 has cooled, it may then be removed from apparatus 10. To remove wax pattern 70, apparatus 10 is opened, and pin 28 of spring lock 26 on second half 14 of apparatus 10 is retracted from aperture 68 in manifold 44, thereby releasing core 30 from its fixed position in apparatus 10.

A source 72 of pressurized gas, such as compressed air, is then supplied to opening 58 in manifold 44 of core 30. The pressurized gas travels through passage 56 in center core piece 36 and out opening 54 in side wall 40a. The pressurized gas travels upward, compressing between wax pattern 70 and top surface 48 of center core piece 36. This compressive force is sufficient to overcome the magnetic forces holding center core piece 36 and outer core pieces 38a-38e together, and center core piece 36 is pushed out of wax pattern 70 and mold cavity 20. Pressurized gas also enters chambers 64 in outer core pieces 38a-38e to maintain outer core pieces 38a-38e in wax pattern 70 as center core piece 36 is expelled. Excess gas and any vacuum or suction created by expulsion of the center core piece 36 is released through vent hole 66, making the removal of center core piece 36 easy.

After center core piece 36 has been expelled, outer core pieces 38a-38e may be individually removed through the opening in wax pattern 70 created by center core piece 36 and directly reassembled onto center core piece 36, so that core 30 is ready for use.

The unencumbered wax pattern 70 may then be removed from mold cavity 20 of apparatus 20. A golf club head is then formed as discussed in U.S. Pat. No. 5,577,550. The club head is typically formed of titanium, steel, titanium alloys, steel alloys, amorphous metals and the like, and can vary in size from 150 cc to 500 cc, more preferably 250 cc to 385 cc, and most preferably 335 cc.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention:

1. A method for forming a hollow wax pattern of a metallic golf club head, the method comprising:
providing a mold having a cavity formed therein;
placing a core into the cavity of the mold, the core including a center core piece and a plurality of outer core pieces removably coupled to the center core piece, the core further including a manifold;
injecting a wax into the mold cavity around the core, the wax forming a pattern of an exterior of the golf club head;
injecting a compressed gas through an opening in the manifold and through a passage in the center core piece to separate the center core piece from the outer core pieces and expel the center core piece from the wax pattern in the mold;
removing the outer core pieces from the wax pattern in the mold; and
removing the hollow wax pattern from the mold.

2. The method according to claim 1, further comprising assembling the outer core pieces to the center core piece prior to placing the core in the mold cavity, the outer core pieces being removably coupled to the center core piece by magnets embedded in the outer and center core pieces.

3. The method according to claim 1, further comprising securing the core in the cavity of the mold, the mold including a spring-loaded lock with a retractable pin, the retractable pin extending into an aperture formed in a side of the manifold of the core.

4. A method for forming a hollow wax pattern of a metallic golf club head, the method comprising:
placing a core into a cavity of a mold, the core including a center core piece and a plurality of outer core pieces removably coupled to the center core piece, the core further including a manifold;
injecting a wax into the mold cavity around the core, the wax forming a pattern of an exterior of a golf club head;
injecting a compressed gas into the center core piece to separate the center core piece from the outer core pieces and expel the center core piece from the wax pattern in the mold;
removing the outer core pieces from the wax pattern in the mold; and
removing the hollow wax pattern from the mold.

5. A method for forming a hollow wax pattern of a metallic golf club head, the method comprising:
injecting a compressed gas into a center core piece to separate the center core piece from a plurality of outer core pieces and expel the center core piece from a wax pattern of a golf club head in a cavity of a mold;
removing the outer core pieces from the wax pattern in the mold; and
removing the hollow wax pattern from the mold.
